(19) United States
(12) Patent Application Publication
(10) Pub. No.: US 2026/0017498 A1
(43) Pub. Date: Jan. 15, 2026

(54) AUTOMATICALLY GENERATING KNOWLEDGE ASSESSMENT ITEMS

(71) Applicant: EXAMROOM.AI CORP., Lake Mary, FL (US)

(72) Inventors: Vinod Kumar JAYAKEERTHI, Sorrento, FL (US); Parshant KUMAR, Bangalore (IN); Ravichandra PANCHAKSHARAM, Bangalore (IN)

(73) Assignee: EXAMROOM.AI CORP., Lake Mary, FL (US)

(21) Appl. No.: 19/251,523

(22) Filed: Jun. 26, 2025

Related U.S. Application Data
(60) Provisional application No. 63/671,394, filed on Jul. 15, 2024.

(51) Int. Cl. G06N 3/0475

(52) U.S. Cl. CPC G06N 3/0475

(57) ABSTRACT

Embodiments of the present disclosure relate to a method, a system, and a computer program product for generating knowledge assessment items for an assessment of candidates in an examination and populating the generated knowledge assessment items in an item bank, the knowledge assessment items including different item types, and the knowledge assessment items being generated using artificial intelligence and machine learning, and further the knowledge assessment items generated (created) by the AI/ML module are authenticated and vetted by a subject matter expert before storing or updating the knowledge assessment item(s) in the item bank.

### RELATED APPLICATION

This application claims priority from U.S. Provisional Patent Application No. 63/671,394 filed on Jul. 15, 2024 at the United States Patents and Trademarks Office titled “AUTOMATICALLY GENERATING EXAM ITEMS,” the contents of which is hereby incorporated by reference in its entirety

### TECHNICAL FIELD

Embodiments of the present disclosure relate to generating (creating) knowledge assessment items, and more particularly to generating exam related knowledge assessment items for assessment of candidates, the knowledge assessment items being generated based on use of artificial intelligence and/or machine learning, the knowledge assessment items being validated, classified and stored in an item bank.

### BACKGROUND

Typically, generating exam items (also generally referred to as knowledge assessment items, and reference to exam items in the present disclosure related to knowledge assessment items) manually or semi-automated is a relatively tedious task for a person (such as a subject matter expert) or group of person (group of experts), as the process of generating/creating exam items from content requires a lot of time, effort, and attention to detail, and also care needs to be taken for generating exam times. Typically, exam items are used in examinations and/or test for assessment of candidates. Typically, generating exam items includes a number of steps, from finding and using a subject matter expert for preparing the exam item from content in specific subject areas, to a reviewer for checking and/or authenticating the exam item, and in certain instance either or both of them are required to approve the exam item, before the exam item may be approved for use in the examination. A typical process involves going through (reading) content with meticulous details, and from the content provided creating a collection of exam items under different item type categories, which includes questions, keys and/or distractors and/or keys to be input by the candidate during the examination etc. The process further includes sorting the exam items by subject and topic, setting a level of difficulty for each item etc. The entire process of manually generating exam items or generating exam items in a semi-automated manner is time-consuming, involves human effort and may be error prone. It is therefore an object of the present disclosure to overcome some or all of these deficiencies mentioned herein and also other deficiencies with the current system for creating exam items and several other deficiencies associated in general with creating exam items.

### DESCRIPTION OF THE DRAWINGS

The detailed description is described with reference to the accompanying figures. Features, aspects, and advantages of the subject matter of the present disclosure will be better understood with regard to the following description and the accompanying drawings. The figures are intended to be illustrative, not limiting, and are generally described in context of the embodiments, and it should be understood that it is not intended to limit the scope of the disclosure to these particular embodiments. In the figures, the same numbers may be used throughout the drawings to reference features and components. In order that the present disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages. Novel aspects characteristic of the present disclosure are set forth in the appended claims, embodiments described herein will be understood by those of skill in the art with reference to the following detailed description and accompanying drawing figures in which like reference numerals indicate similar or identical features and components.

FIG. 1 illustrates a high-level exemplary architecture 100 for creating items (exam items) in accordance with an embodiment of the present disclosure.

FIG. 2 illustrates a high-level exemplary environment 200 for creating items (exam items) in accordance with an embodiment of the present disclosure,

FIG. 3 is an exemplary illustration of a method for providing input to the AI/ML module in accordance with an embodiment of the present disclosure,

FIG. 4 illustrates an exemplary method of vetting the item(s) created in accordance with an embodiment of the present disclosure.

### DETAILED DESCRIPTION

Embodiments of the present disclosure relate to a method, a system, and a computer program product for generating knowledge assessment items (hereinafter also generally referred to as exam items in the present disclosure), wherein the exam items may be used for assessment of candidates in an examination. Embodiment of the present disclosure also relates to populating the exam items in an item bank and building a repository of exam items and also updating existing exam items, where the exam items includes different item types. Embodiments of the present disclosure relate to the exam items being generated (also referenced to as created) using artificial intelligence and/or machine learning models and/or algorithms that may be customized for the specific purpose of generating exam items based on content provided as input. Embodiments of the present disclosure relate to the exam items that are generated (created) by the AI/ML module being authenticated and vetted by a subject matter expert prior to storing and/or updating the exam item(s) in the item bank, wherein the item bank is a repository of exam items covering different subject areas, varying from exam items for a general assessment to very specific technical areas.

In an exemplary case, with recent advances and the advent of technology, especially related to Artificial Intelligence (hereinafter referred to as AI) or Machine Learning (hereinafter referred to as ML), AI/ML models (tools) and/or algorithms may be customized and may be used for the task of generating (creating) exam items, which make it much easier and more efficient compared to generating exam items by humans. Using trained AI/ML tools may provide an advantage for generating exam items where such AI/ML tools are provided with a proper input and the requirements may be to generate the required output, which may be exam items. Further, these AI/ML tools may be self-trained and/or self-learning and may be useful for generating a variety of exam items under different item types on the requirements provided as input to the AI/ML tools. In an exemplary case, if content in a particular subject area is provided to an AI/ML tool as input and additionally the number of exam items and item types are mentioned, the AI/ML tool may be configured to provide the required output, exam items, based on the subject area, and further also connect the exam items to other relevant subject areas, as the exam items generated in one subject area may be relevant to other subject areas. In an exemplary case, exam items created from content provided as input in the subject area of physics may be relevant to mechanical engineering or electrical engineering etc. However, a disadvantage of the AI/ML tool is that if the number of exam items and/or item types is a requirement along with the content, and unless at least one of these inputs is provided, the AI/ML model may not any generate exam items, and another disadvantage is that AI/ML models may contain duplicated exam items or multiplicity of exam items, leading to other issues and problems for subject matter experts and/or administrator. Hence, using AI/ML tools also need a certain amount of human intervention in terms of the inputs that may be required for the AI/ML tools such that the AI/ML tools work efficiently. In an exemplary case, AI/ML tools may be designed for generating exam items (also referred to as items) and providing a streamlined and automated solution for this process of creating items from a given content, which may be applicable to different subject areas. In an exemplary case, by leveraging the power of AI/ML, the heavy lifting process of generating exam items is taken care of, freeing up time, resources, cost etc., where resources such as subject matter expert may focus on other important tasks such as vetting and authenticating the exam items and/or any other tasks, as the task for generating exam items may be very tedious, cumbersome, time consuming and a lot of human effort.

In an exemplary case, automating the process of exam item generation with AI/ML technology, for example, can save time and reduce the stress associated with preparing questions manually, such as teachers (subject matter experts) and therefore allows the subject matter experts to focus their time and energy on other matters and/or areas, which include and are not limited to providing the best possible education to students and/or creating exceptional educational material for students. An exemplary case of the present disclosure includes generating or creating exam items, and herein exam item may be references as items in general and may also be referenced as knowledge assessments items and these terms may be interchangeably used, and these exam items may be administered for assessment of candidates in an examination. In an exemplary case, an AI/ML module (which may also be referenced to as a tool in the present disclosure) may be adapted for receiving as input, content from a source, where the content is related to a certain subject area or a specific subject area, and the source may be a subject matter expert, an examination administrator, a client, and a third party acting on behalf of a client. In an exemplary case, from the input received, the AI/ML module may be configured for which exam generating (creating) exam items from the content. In an exemplary case, once the content is input, the AI/ML model may prompt the source other parameters that may be a requirement for generating exam items or may suggest the set of parameters based on self-learnt lessons, wherein in one instance the set of parameters may include and not be limited to the number of exam items to be generated, the number of exam item types to be generated etc., and providing at least a minimal set of parameters along with the content as input may be mandatory for the AI/ML module to perform an action of generating exam items.

A further exemplary case may include providing the content received from the source as input to an artificial intelligence and/or a machine learning (AI/ML) module, wherein the AI/ML module is pre-trained to perform one or more specific action, and in this case one of the action may be generating exam items in addition to other actions. In an exemplary case, one specific action of the AI/ML module may include generating exam items from the content received and from the other set of parameters provided as input along with the content from the source, and the exam items are created from the content as per the requirement provided by the source, where the source may include a user and/or teacher and/or an examination administrator and/or a client and/or a subject matter expert and/or a third party acting on behalf of the client, where the third party is an authorized third party. In an exemplary case, the source providing the input to the AI/ML module and the source requiring the exam items from the content provided may be the same person, such as a teacher or may be two different persons, such as a teacher and examination administrator. It should be obvious to a person or ordinary skill in the art that several such variations are possible and that all such variation fall within the scope of the present disclosure. A further exemplary case includes providing as output from the AI/ML module at least one or more exam items with respect to the content provided as input by the source. In an exemplary case, the exam items generated in differing item types may be stored in an item pool or item bank creating a repository of items, which may be referenced for preparing a set of items to be administered in an examination.

As referred to herein, in an exemplary case, an ‘item’ or ‘exam item’ or ‘knowledge assessment item’ in the context of the present disclosure generally refers to a question and a set of keys (hereinafter also referred to as answers), where the keys may be in different formats, and the keys are with respect to the question. In an exemplary case, the items created may be categorized subject area wise and stored in a repository (hereinafter may also include a database and the database may be structured or unstructured) from where the items may be selected for the creation of the test package and administered to candidates based on a test specification. In an exemplary case, each item created may be stored in the item bank by classifying the items by a subject matter expert, and may be categorized into multiple subject areas, which may advantageously be achieved by means of a mapping between the item and the subject area and/or multiple subject areas. In an exemplary case, the mapping for example may be a lookup table or some other relationship means that may be used for the categorization of the items and the subject area.

In an exemplary case, the AI/ML module may be a self-trained module and/or self-learning module hosted on a test administration server (herein also referred to generally as a server, and reference herein to server implies a test administration sever with an AI/ML module, which amongst other actions is configured for generating exam items), wherein the server comprises at least one of a Central Processing Unit (CPU), a Graphics Processing Unit (GPU) and a Tensor Processing Unit (TPU), and/or a combination thereof, wherein the at least one of the CPU, GPU and TPU is coupled to a memory configured to execute specific instruction and in this particular case for generating exam items, classifying the exam items and storing the exam items in an item bank. In an exemplary case, the AI/ML module may be configured to receive feedback from the source, and the feedback received from the source may be routed back to the AI/ML model and used for training the AI/ML module, and validation for the AI/ML module may be performed by an administrator and/or an authorized source.

In an exemplary case, the content provided to the AI/ML module may include at least one from an audio source, a video source, a journal, a book and/or a hyperlink and/or a combination thereof. In an exemplary case, at least a total number of items to be created from the content provided may also be specified by the source as an additional input to the AI/ML module, failing which the AI/ML module may not function or the AI/ML module based on past learning make suggestions to the source for providing such inputs, such that the AI/ML module may generate exam items. In an exemplary case, the source may include at least one of a user requesting for the exam items to be created, a client, a third-party on behalf of a client, a subject matter expert, and/or an examination administrator.

In an exemplary case, the source providing the content may also additionally be required to input a set of pre-defined parameters, such as the total number of items and the number of item types to be created by the AI/ML module from the content received as input to the AI/ML module. In an exemplary case, the set of pre-defined parameters may include at least one of an item type, and at least a maximum number of items to be created under each of the item type in addition to any other parameters. In an exemplary case, the item type may include at least one of a dichotomous item type or a polychotomous item type, and may be also included as one of the set of pre-defined parameters. In an exemplary case, each of the item may include a stem, a set of keys, and/or a set of distractors and/or a requirement to be an input to the stem. In an exemplary case, the number of keys and/or the number of distractors for each item may also be specified by the source, wherein the number of keys and/or the number of distractors for a stem is determined based on the item type. In an exemplary case, if an item type is not specified by the source, the AI/ML model may be configured to self-generate items of different item types, and the total items not exceeding the number of total items specified by the source. In an exemplary case, the AI/ML module may propose the number of items, number of item types etc., based on previously used data provided from self-learning, which may be changed by the source.

In an exemplary case, the source may be configured to scrutinise, validate and approve the items created by the AI/ML module from the content provided. In an exemplary case, the source may provide feedback to the AI/ML module, wherein the feedback provided to the AI/ML module may be used for training the AI/ML module, for self-learning and development of the AI/ML module, enhancing the capabilities of the AI/ML module. In an exemplary case, the subject matter expert may offer suggestions to the AI/ML module to change an item created and provide feedback to the AI/ML module on the change suggested to the item under consideration, wherein the feedback is provided to the AI/ML module for training the AI/ML module.

In an exemplary case, the subject and/or topic, which may be defined as the input content, for generating the items may be defined/provided by the source, and the source may include and not be limited to a subject matter expert and/or a user and/or a teacher and/or an examining authority (also referred to as an examination administrator or simply as an administrator) and/or a client and/or a third party acting on behalf of a client and/or a combination thereof. In an exemplary case, in accordance with the embodiments of the present disclosure the subject and/or topic is collectively referred to as content, and the content may be provided as input to the AI/ML module for generating items from the content. In an exemplary case, if there is no content and only a set of parameters provided to the AI/ML module, the AI/ML module may prompt the user/source to provide the content to generate exam items. In an exemplary case, the AI/ML module may be pre-trained for performing one or more action, based on the input received, wherein the action includes automatically generating exam items from the content and/or prompting the user to provide proper inputs for generating exam items. It should be obvious to a person of ordinary skill in the art that the AI/ML module may be designed to perform several other actions that are not specifically listed here, and all such action that may be used for the purpose of generating and validating exam items falls within the scope of the present disclosure. In an exemplary case, once the item or plurality of items is created (generated) from the content provided, embodiment of the present disclosure includes providing as output from the AI/ML module the at least one or more items to the source for assessment of the item(s), validation of the items(s) and feedback on the item(s), wherein receiving feedback and implementing the feedback may be another specific action performed by the AI/ML module. In an exemplary case, at least one of the total number of items to be generated and the type of items to be generated and the number of items in each type of item may be provided as input to the AI/ML module along with the content, with at least one of these set of pre-defined parameters being mandatory for the AI/ML module to generate exam items, failing which the AI/ML module will not generate any exam items. In an exemplary case, the assessment, validation and feedback with respect to the items may be routed back to the AI/ML module for self-learning and training and/or re-training the AI/ML module.

In an exemplary case, the content may include at least one of and not be limited to an audio source, a video source, an audio-visual source, a journal, publications, web pages, books, a combination thereof, etc. In an exemplary case, input of the content may be provided via different sources/formats such as an optically scanner, a web page, a link to a web page, a blog etc. In an exemplary case, multiple options may be provided for creating the items with respect to the content. In an exemplary case, the subject may include certain chapters of books and a link to a web page which describes the content. It should be obvious to a person of ordinary skill in the art that any information and/or data may be selected and used as content to be provided as input, and all such information and/or data falls within the scope of the present disclosure. In an exemplary case, the AI/ML module may be integrated into a computer system in terms of a software, as a hardware, as a firmware and/or a combination thereof.

In an exemplary case, the AI/ML module receives as input from the source in addition to the content, at least one item type and the number of items in the item type and/or a total number of items from the source, wherein the additional input in addition to the content may be a mandatory requirement to be provided by the source. In an exemplary case, when the number of items is not specified, and if item type is selected, the AI/ML module may automatically generate at least one or more items from the content provided in the items types selected, and the total number of items to be generated in the item type may contain duplicate or multiplicity of items, where the AI/ML module is configured to identify duplicate and/or multiplicity of items and discard the duplicate items. In an exemplary case, based on previous learning, the AI/ML module may restrict the number of items being generated if only the item types are specified. In an exemplary case, the AI/ML module is thereby preventing from generating items continuously, and when the AI/ML module detect duplicate items being generated, the AI/ML module may stop generating items.

In an exemplary case, the number of items to be created (interchangeably used with generated) from the content is also provided as an input to the AI/ML module by the source. In an exemplary case, the number of items in each item type category and/or if the total number of items to be generated should be at least specified to the AI/ML module, such that the AI/ML module can generate the required exam items. In an exemplary case, in addition to the content, at least the total number of items to be generated and/or the category/type of items to be generated and the number of items in each item type may be specified to the AI/ML module by the source, or may be suggested by the AI/ML module based on previously used cases of similar type. In an exemplary case, the number of keys and/or the number of distractors for the items may also be specified by the source. In an exemplary case, the number of keys and/or the number of distractors for each the items may be determined based on the item type, which may also be done by previously used cases of similar types.

In an exemplary case, if an item type is not specified by the source, but the content and number of items to be created are specified by the source to the AI/ML model, the AI/ML model may generate items in different item types, and preferably the items generated may be a best representation of all types of items form the content provided, and in an exemplary case, previously used cases may be used by the AI/ML module. In a preferred case, the content and the number of items provided to the AI/ML module, the module may generate items in one item type, such as multiple choice questions. In an exemplary case, each item created may be collated together into various groups, if the AI/ML module can identify more than one other group to fit the item, a robust item bank may be created, where the groups may be categorized by the AI/ML module or the subject matter expert.

In an exemplary case, each item created may fall under different subjects and topics, and it should be obvious to a person or ordinary skill in the art that the item created may be grouped into all such different subject and topics, which may be done automatically by the AI/ML module and/or with the help of the source such as a subject matter expert. In an exemplary case, if the content is related to topic 1 and the item created is additionally related to topic 2, topic 3, etc., the AI/ML module may intimate the subject matter expert that the item may be assigned to topic 2 and/or topic 3 based on the relevancy of the subject area. The subject matter expert may accept or reject the proposal of the AI/ML module, and any feedback provided along with the decision of the subject matter expert may be routed back to the AI/ML module for self-learning, making the Ai/ML module robust for future use. In an exemplary case, the self-trained AI/ML module may identify that the item may be relevant to topic 2 and/or topic 3 and update the item for validation to be added to the topic 2 and/or topic 3 after validation by the same subject matter expert and/or a different subject matter expert depending on the topic identified, and on validation add the item into the relevant topic in the item bank relevant to that topic.

In an exemplary case, the item bank includes a repository of items, which may be grouped into different subjects and/or topics, by one or more subject matter experts. In an exemplary case, the respiratory may be structured data, unstructured data or a combination thereof. In an exemplary case, the source (user/SME/EA) may be configured to scrutinise, authenticate and validate each of the item(s), and the decision with respect to the item(s) may be processed, which includes approving or disapproving or suggesting changes to the item(s) created by the AI/ML module, and a relevant action may be taken on the decision. In an exemplary case, the source may provide feedback with respect to the items and the feedback may be provided to the AI/ML module, wherein the feedback may be used to update and/or upgrade the capabilities of the AI/ML module. In an exemplary case, the source may be configured to offer suggestions to the AI/ML module to change the item, and such feedback may also be provided to the AI/ML module for continuous learning and improvement of the AI/ML module.

In an exemplary case, the item may include at least one of a dichotomous item type or a polychotomous item type. In an exemplary case, the dichotomous item type may be a True or False statement and not limited to the true or false type of item, and may be a radio button type of selection to select the right key. In an example case, the polychotomous item type may be multiple choice type and/or multiple response type and/or match the following and/or any other type of item does not fall under dichotomous item type. In an exemplary case, it should be obvious to a person of ordinary skill in the art that all items created belong to and may be classified under the dichotomous item type or polychotomous item type. In an exemplary case, the level of difficulty of the item may be set by the source, either by the subject matter expert and/or an AI/ML module. In an exemplary case, a single question may be having a low difficulty level, a medium difficulty level and a high difficulty level, with appropriate keys, where only three level ae provided, and there could be many other levels, wherein each question and key forming an item may be assigned a score between 1 to 10, where the score may be indicative of the level of difficulty for the item. In an example case, the item may include at least one of a traditional item, non-traditional item, judgement item, non-judgemental clinical item, non-clinical item, next generation items, etc.

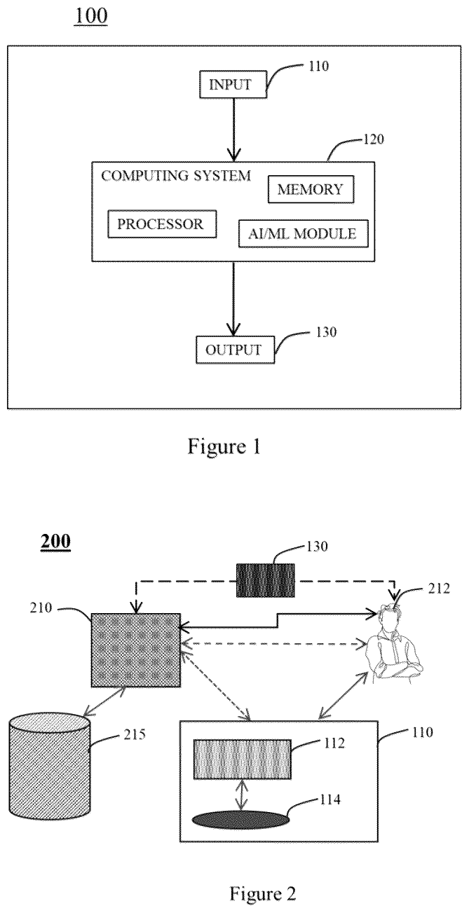

Reference is now made to FIG. 1, which illustrates a high-level exemplary architecture 100 for creating (generating) items (exam items, knowledge assessment items) in accordance with an embodiment of the present disclosure. Architecture 100 includes at least computing system 120, which has a memory and processor and may be configured to run an AI/ML module coupled with computing system 120. Computing system 120 may include at least CPU/GPU/TPU, memory, storage devices, and input/output units, other components and the function of these components is to work together to process and store data, execute programs, and communicate with external devices. Computing system 120 may be specifically designed for generating items and storing the items in an item bank, preferably by an AI/ML module coupled to computing system 120. Computing system 120 (which may also be hereinafter referred to as a computing device) is capable of receiving input 110, wherein the input is identified by a source and provided to computing system 120, the input being identified content sources and at least a set of predefined parameters as discussed previously. Based on input 110 received by computing system 120, the computing system processes the content and may be configured to provide an output of 130, where the output 130 in accordance with the embodiments of the present disclosure is specifically related to exam items(s). In an exemplary case, computing system 120 may include any device that has at least a processor and a memory, and also in accordance with the embodiment of the present disclosure computing system 120 may additionally include an AI/ML module and/or computing system 120 may be coupled to an AI/ML module, where the AI/ML module may be a separated from the computing system, however the AI/ML module using the computing system to perform the task as identified by the embodiments of the present disclosure. The AI/ML module may be a software module, a hardware module with embedded code, a firmware and/or a combination thereof. It should be obvious to a person of ordinary skill in the art that the embodiment of the present disclosure are related to generating items using a AI/ML module, preferably using a trained AI/ML module, and any AI/ML algorithm and/or AI/ML tools readily available may be customized for the purpose, which creates items from content and other pre-defined set of parameters provided as input by the source, where the set of pre-defined parameters may include and not be limited to the total number of items, number of items types, number of items under each item type etc. In an exemplary case, the AI/ML module may be custom built and designed for the specific purpose of creating items from content and set of pre-defined parameters provided as input by a source and any other specific inputs provided by the source. It should also be obvious to a person of ordinary skill in the art that any computing system 120 having at least a processor and a memory and configurable to perform the operation as defined in the embodiments of the present disclosure include and is not limited to laptop computers, mobile phones, PDAs, desktop computers, servers etc., and the computing system may additionally host the AI/ML module, and all such devices fall within the scope of the present disclosure. It should also be obvious to a person of ordinary skill in the art that the AI/ML module may be a separate system, that may be coupled to computing device 120 via a wired network and/or a wireless network and/or a combination thereof, and all such variations fall of separated systems that may be distributed within a network or any could-based system that may be employed to generate exam items with an AI/ML module fall within the scope of the present disclosure.

As illustrated, FIG. 1 is a simplistic overview of an architecture 100, including a computing system 120, the computing system configured for receiving input 110 (content and pre-defined set of parameters) from a source (not shown in Figure) in a specific format, and the configured to generate output 130 for the source, which will be described in more detail with respect to FIG. 2 below. Source here may refer to an examination administrator, a client, a teacher, a third party acting on behalf of a client or any other authorized person and in the present disclosure may also be essentially referred to generally as a ‘user’ who provides the input and requires items to be generated from the input. Input 110 is provided to computing system 120 (device and system are interchangeably used in the present disclosure), wherein the input includes content and a set of pre-defined parameters and any other specific instructions required by the AI/ML module for generating the items from the input. In an exemplary case, the set of pre-defined parameters may include and are not limited to the number of items to be generated, the kind of item types, the number of items to be generated under each item type etc. Computing system 120 is configured to process input 110 by the AI/ML module and generate the desired output 130, wherein output 130 is at least one or more items in the at least one or more item type category. The number of items required to be generated by the AI/ML module at least one of the parameters specified from the set of pre-defined parameters as input 110 in addition to the content, or alternatively the AI/ML module may prompt the source with these parameters from past learnings, which may be accepted or changed by the source.

Reference is now made to FIG. 2, which illustrates an exemplary environment 200 (architecture) for generating (creating) items (knowledge assessment items or exam items) in accordance with an embodiment of the present disclosure. Environment 200 (hereinafter also referred to as architecture) includes source 212, wherein source 212 may be a user who is desirous of generating items from content using the AI/ML module. The AI/ML module may be configured to automatically generate items from content 112 and a set of pre-defined parameters 114 provided as input. The source may include at least one of and not be limited to a subject matter expert, a teacher, an examining authority (administrator), a client, a third party acting on behalf of the client, any other authorized person etc. Input 110 to AI/ML module at least includes content 112 and a set of pre-defined parameters 114 (also hereinafter referred to as parameters or other parameters), wherein at least the content and a few objects/elements from the set of parameters are mandatory requirements as input to the AI/ML module for generating items. In an exemplary case, at least a few of the objects/elements from the set of parameters are provided, else the AI/ML module may suggest these parameters from past learnings and usage. At least one parameter from the set of pre-defined parameters, such as the total number of items may need to be specified as an input along with the content. Based on input 110, which includes the content and the set of pre-defined parameters, AI/ML module may be configured to generate item(s) as per the requirement of source 212.

Content 112 may include and not be limited to at least one of an audio source, a video source, an audio-visual source, a journal, a book, webpages, links etc. In an exemplary case, if content 112 is identified as a book, an online copy of the book may be provided to computing system 210. In an alternative exemplary case, content 112 may be input to computing system 120 by means of an optical scanner (not shown in figure), where the optical scanner may be coupled to the computing system 210, and the optical scanner being configured to read the part of the content in the book and provide content 112 as part of input 110 to AI/ML module of computing system 120 in addition to the set of pre-defined parameters in order to generate item(s). In an exemplary case, it should be obvious to a person of ordinary skill in the art that content 112 may be provided by various other alternative means to computing system 120, which are not discussed and/or presented in the present disclosure, and all other means being used by source 212 to provide content 112 to computing system 210 for the purpose of generating items(s) falls within the scope of the embodiments of the present disclosure.

Input 110, in addition to content 112, further include other parameters 114 (also referred to as set of pre-defined parameters or set of parameters) to be specified to the AI/ML module, wherein the other parameters may include and not be limited to a total number of items to be generated, a difficulty level associated with the items that are generated, a number of item types, the number of items to be generated in each item type etc. In an exemplary case, it should be obvious to a person of ordinary skill in the art that at least content 112 and the total number of items to be generated from the content in other parameters 114 may be the minimal requirements as an input 110 that may be required for the AI/ML module of computing system 210 for generating the exam items in accordance with the embodiments of the present disclosure.

The AI/ML module may be hosted within computing system 210 as part of the computing system or may be hosted separately on another device and coupled to computing system 210 by wired means and/or wireless means and/or a combination thereof. The AI/ML module is pre-trained for the purpose of creating (interchangeably used as generating) items by receiving input 110 from source 212, and the AI/ML module is configured to provide a desirous output 130 in response to the input, wherein the output is exam items generated based on the requirement of source. The items(s) generated as output 130 may be provided back to source 212 to analyze, scrutinize, validate and approve the item(s) created, and also any associated feedback provided by source may be collected and provided back to the AI/ML module for self-learning and/or self-training of the AI/ML module.

Source 212 based on output 130 received from computing system 210, may request a change to the item(s) generated by the AI/ML module after reviewing the item(s). Any item requiring change may be provided back to AI/ML module with a change request and reason and/or feedback, wherein the change request from the user is used to revise the item, and the feedback is used for self-training and/or self-learning for improvement of the AI/ML module by continuously training the AI/ML module. The AI/ML module may consider this feedback and adapt the feedback provided for future use on detecting similar instances of input from a source. The AI/ML module is configured to identify duplicate and/or multiple items and discard the duplicate and/or multiple items that may be generated, especially in the same item type category. In an exemplary case, the AI/ML module may check the items generated for duplicity and eliminate duplicate items such that items duplicated items are not provided to the source for reviewing.

Each item created by the AI/ML module may be at least one of a dichotomous item type or a polychotomous item type, which have been discussed previously. In an exemplary case, the item generated may be at least one of and not limited to a traditional item, a clinical judgement item, a next generation item or any other type of item as discussed previously. Once the item(s) that has been created by the AI/ML module is scrutinized, vetted and/or authenticated by source 212, the item(s), appropriate action may be initiated by the AI/ML module of redirecting the item(s) and storing the item(s) in a repository 215, wherein each of the item may be classified into different subject and topics, and may be automatically placed in relevant categories and/or with the help of source 212 be placed in relevant categories. The collection of item(s) may create an item pool (also referred to as item bank). Repository 215 may include one or more item banks and other data in addition, but reference to repository 215 herein is reference specifically made to the item bank and/or item pool. Source 212 may be provided with rights and privileges to scrutinise and/or validate and/or approve the item created by the AI/ML module and provide feedback on the item(s). The feedback is provided to the AI/ML module which is used for continuous learning and improvement of the AI/ML module. It should be obvious to a person of ordinary skill in the art that any available AI/ML algorithms and/or modules and/or tools may be configured and customized to execute the above-mentioned method for generating items, and all such AI/ML algorithms and/or modules and/or tools fall within the scope of the embodiments of the present disclosure.

If an item type is not specified by source 212, the AI/ML model may identify a set of parameters that may be pre-stored with respect to the specific content type and/or user and/or any other instance and generate items of different item types, wherein the item(s) generated may be the best possible representing the content. In an exemplary case, if the item type is not specified, based on previous learning the AI/ML module may generate item(s) in the category of multiple-choice questions and keys. In an alternative case, the total number of items may be restricted to the number provided by the source 212, and the AI/ML model may use this input as a mandatory requirement to the AI/ML module. Alternative, based on past learning, the AI/ML module may be configured to automatically provide or intimate source 212 with a set of parameters 114 that may be used to generate the item(s) from the content, and these suggestions made by the AI/ML module may be approved by source 212 and/or may be changed by source 212.

Repository 215 includes an item bank, where the item bank may include a number of items under various subjects and topics, and item(s) may be categorized by source 212 and updated by AI/ML module. Alternatively the AI/ML module may be configured to suggest the category for each of the item(s) and on validation of the category and item by source 212 dynamically updated repository 215 with the items in the item bank. Updating of repository 215 with item(s) may be performed automatically and/or on instruction of source 212. Further, the AI/ML module receives as input at least one item type from the source and based on the item type the AI/ML module may be configured to generate the at least or more one item(s) but is restricted to the total number of items requested by source 212. Repository 215 may contain items such as structured data, unstructured data or a combination thereof.

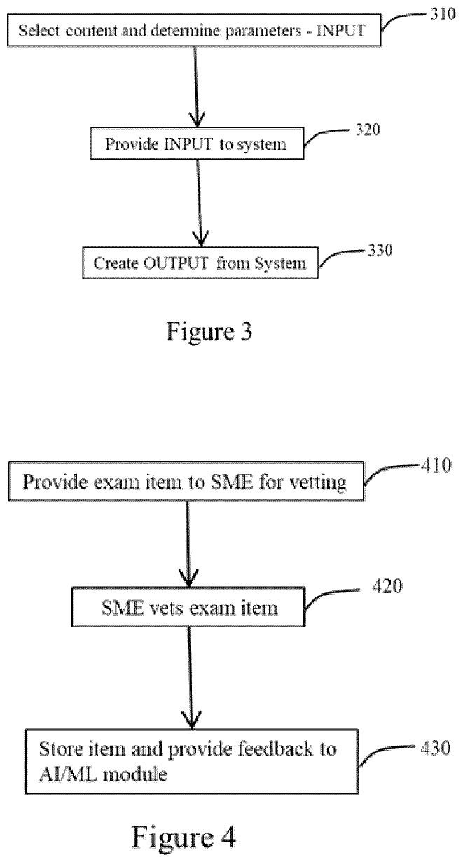

Reference is now made to FIG. 3, which is an exemplary illustration of a method for providing input to the AI/ML module in accordance with the embodiments of the present disclosure. In step 310, content is selected with other parameters (input), and the content and at least one of the other parameters is prepared as requirement that servers as the Input for the AI/ML module. In step 320, the input from step 310 is provided to the AI/ML module, where the AI.ML module check the input and if there are any discrepancies, identifies those and prompts the user to correct those. Alternatively if the user provides only the content and request the AI/ML module to generate item(s), the AI/ML module may prompt the user to select the set of parameters by suggesting the parameters from previous learnings. Once the input is identified to be in proper format, the AI/ML module accepts the input and begins the task of generating items. In step 330, from the content and other parameters provided as input, the AI/ML module generates at least an item or a plurality of items under different item types as output, which is provided to the user.

The content and at least one or more parameters from the set of parameters are provided by a source as defined previously. The input provided to AI/ML module is for the purpose of generating items. The content provided to the AI/ML module may include at least one of an audio source, a video source, a journal, a book, webpage, a hyperlink and a combination thereof as discussed previously. The set of pre-defined parameters may include at least the total number of items to be created from the content provided, the source of the content, the number of item types, the number of items in each item type etc., as discussed previously. Several other parameters may be devised for the AI/ML module to generate item(s) from the content, such as and not being limited to difficulty levels of items etc., and may be additionally provided as input to AI/ML module and all such parameters provided to the AI/ML module for generating items fall within the scope of the present disclosure. The content may be specific to a subject and/or a topic and item(s) generated are specifically intended for that subject and/or topic but may also be related to other subject area and/or topics. In an exemplary case, if there is content related to basic electricity, items may be created in different subject areas such as Physics, Electrical engineering, Mechanical engineering, etc. In an exemplary case, a single item created from the content may be placed under multiple subjects and/or topic categories in the item bank, which may be done post validation by source and/or suggestion by the AI/ML module to choose a category for the item.

Based on the content and the other parameters provided to the AI/ML module of the system, the AI/ML module is configured to perform an action, wherein the action may be generating items and/or receiving feedback and self-evaluating and/or proposing parameters to the source etc. It should be noted here that the AI/ML module may be pre-trained for generating items and may be also configured to continuously receive feedback from the source in order to self-train itself and improve its performance in creating items over time. The item created is based on an item type specified by the source to the AI/ML module, wherein the item includes at least one of a dichotomous item type or a polychotomous item types. The number of items and the item types may be specified by the source. In the absence of any item type being specified by the source, based on the training that is provided to the AI/ML module, the AI/ML module may create items that best fit the content in different item types. The items created by the AI/ML module may be and not limited to traditional items, clinical judgement items, next generation items etc. The AI/ML module may check for duplicity of items and eliminate duplicate items that are created before providing the items to the source for scrutiny, validation and/or authentication, and populating the item bank.

In an exemplary case, the items created may be collated together form one or more item banks. In an exemplary case, the item bank may be specifically owned by an organization, such as a University and/or an examination authority and/or a corporate and/or may be a common item bank maintained by an examination administrator (authority) such as EXAMROOM.AI® who may be proficient in conducting the examination on behalf of the organizations listed above, and/or the item bank may be created and/or owned by an authority such as EXAMROOM.AI® and/or any other third party, which may be licensed to any one of the above mentioned organizations. In an exemplary case, examination administrator such as EXAMROOM.AI® may own the AI/ML module and may create items for the client and/or tenant based on content provided by the client and/or tenant.

It should be obvious to a person of ordinary skill in the art that input, i.e., content, may be provided by various means over a communication network or via a port, such as a USB port etc., and all such variation falls within the scope of the present disclosure. In an exemplary case, the content may be provided as a link from the Internet or book on a USB which may be coupled to a processing device containing software and/or hardware and/or firmware that is configured to read the USB and generate items automatically from the content provided. In another exemplary case, content may be provided by means of an optical scanner wherein the processing device may be configured to read the content as input for generating items from the content provided. Several other variations may be possible, and it should be obvious to a person of ordinary skill in the art that all such variations fall within the scope of the present disclosure.

Reference is now made to FIG. 4, which illustrates an exemplary method of scrutinizing, vetting and/or authenticating the item(s) created in accordance with an embodiment of the present disclosure. In step 410 the item created from the content and the pre-defined criteria provided as input to the AI/ML module, where the item generated as the output from the AI/ML module is provided to the source for scrutinizing and/or vetting and/or authentication, which includes scrutinizing the item(s) and/or approving the item(s) ad/or rejecting the item(s) and/or providing feedback on the item(s) and/or providing feedback on the decision with respect to the item(s) to the AI/ML module. In step 420, the source scrutinizes and/or authenticates and/or validates the item(s) created and may approve and/or reject and/or offer suggestions for change of the item. With every decision that is made with respect to the item generated by the AI/ML module, the feedback with respect to the item(s) is also attached that is provided to the AI/ML module for self-learning and further use. In step 430, if the item is approved, the item is stored in the selected category (subject area/technical field etc.). If the item is rejected, the item is discarded, and feedback is provided to the AI/ML module. If a change is required, the item is sent back to the AI/ML module with feedback requesting for the specific change with respect to the item. Any suggestions made by the subject matter expert are provided to the AI/ML module, where the feedback is taken by the AI/ML module and is configured to suitable amendments to the item and the process with respect to FIG. 3 and FIG. 4 is repeated until the item is approved or declined by the source. If the items are relevant to another categories, then subject matter experts form the other subject areas may be requested to authenticate and vet the item, and post this action, suitably updating the item in the item bank. Specifically references to FIG. 3 and FIG. 4 are discussed in more details with respect to FIG. 2.

Although the present disclosure has been described with reference to several preferred embodiments, it should be understood that the present disclosure is not limited to the preferred embodiments disclosed here. Embodiments of the present disclosure are intended to cover various modifications and equivalent arrangements within the spirit and scope of the appended claims. Although the foregoing disclosure has been described in some detail for purposes of clarity of understanding, it will be apparent that certain changes and modifications may be practiced within the scope of the appended claims. Examples of the present disclosure have been described in language specific to structural features and/or methods. It should be noted that there are many alternative ways of implementing both the process and apparatus of the present invention. Accordingly, embodiments of the present disclosure are to be considered illustrative and not restrictive, and the invention is not to be limited to the details given herein but may be modified within the scope and equivalents of the appended claims. It should be understood that the appended claims are not necessarily limited to the specific features or methods described. Rather, the specific features and methods are disclosed and explained as examples of the present disclosure

What is claimed is:

1. A method for generating an item for knowledge assessment of a candidate, the method comprising:
an AI/ML module coupled to a computing device, the AI/ML module adapted for
receiving as input, content and at least a set of parameters from a source;
based on the input received, the AI/ML module adapted to perform an action, the action comprising:
generating at least one or more knowledge assessment items from the content received as input, wherein the item is at least one of a dichotomous item type or a polychotomous item type; and
providing as output at least the one or more knowledge assessment items with respect to the content provided as input.

2. The method of claim 1, wherein the action for for generating the knowledge assessment items by the AI/ML module comprises performing at least one of a Retrieval-Augmented Generation (RAG) framework, a Knowledge Augmented Generation (KAG) framework, a Model context protocol (MCP) framework, a generative AI framework, a transformer model framework. a deep learning model, an elastic weight consolidation (EWC) model, an instructor-based training model, progressive neural network model, a learning without forgetting model, a memory replay system model and a vector-based model and McCulloch-Pitts Neuron (MCP) framework.

3. The method of claim 1, wherein the AI/ML module includes a self-training module and a self-learning module, the AI/ML module hosted on the computing device, wherein the computing device comprises at least one of a Central Processing Unit (CPU), a Graphics Processing Unit (GPU) and a Tensor Processing Unit (TPU), wherein the at least one of the CPU, GPU and TPU is coupled to a memory.

4. The method of claim 1, wherein the AI/ML module is configured to receive feedback on the knowledge assessment items generated from the source.

5. The method of claim 4, wherein the feedback is validated by the source, the source comprising at least one of an examination administrator, a client and an authorized third party on behalf of the client wherein feedback acting as input for model learning.

6. The method of claim 1, wherein the content comprises at least one of an audio source, a video source, a journal, a book, a hyperlink and a combination thereof, wherein the hyperlink includes content therein.

7. The method of claim 1, wherein the set of parameters provided as input comprises at least a total number of knowledge assessment items to be generated, and the total number of knowledge assessment items to be generated further comprises:
at least one of an item type; and
at least a maximum number of knowledge assessment items to be created under each of the item type.

8. The method of claim 7, wherein the each of the knowledge assessment item comprises at least one of
a stem and a set of keys for the stem;
a stem, a set of keys for the stem and a set of distractors for the stem; and
a stem and an input requirement for the stem, wherein the input requirement for the stem is provided by the candidate, and
wherein the number of keys and the number of distractors for each item is specified by the source, wherein the number of keys and the number of distractors for a stem is determined based on the item type.

9. The method of claim 1, wherein if an item type is not specified by the source, the AI/ML model is configured to self-generate knowledge assessment items of different item types, wherein a total number of knowledge assessment items generated from the content not exceeding the total number of total items specified by the source.

10. The method of claim 1, wherein at least one of
the source is configured to scrutinise and approve the knowledge assessment item generated by the AI/ML module, and provide feedback with respect to the knowledge assessment item, wherein the feedback provided trains the AI/ML module; and
a subject matter expert configured to offer suggestions to change the knowledge assessment item generated by the AI/ML module and provide feedback the change suggested to the knowledge assessment item, wherein the feedback is provided to train the AI/ML module.

11. A computing system with one or more processors and a memory, the system comprising an artificial intelligence/machine learning module (AI/ML module) when active the AI/ML module is configured for:
an AI/ML module coupled to a computing device, the AI/ML module adapted for
receiving as input, content and at least a set of parameters from a source;
based on the input received, the AI/ML module adapted to perform an action, the action comprising:
generating at least one or more knowledge assessment items from the content received as input, wherein the item is at least one of a dichotomous item type or a polychotomous item type; and
providing as output at least the one or more knowledge assessment items with respect to the content provided as input.

12. The system of claim 11, wherein the action for generating the knowledge assessment items by the AI/ML module comprises performing at least one of a Retrieval-Augmented Generation (RAG) framework, a Knowledge Augmented Generation (KAG) framework, a Model context protocol (MCP) framework, a generative AI framework, a transformer model framework. a deep learning model, an elastic weight consolidation (EWC) model, an instructor-based training model, progressive neural network model, a learning without forgetting model, a memory replay system model and a vector-based model and McCulloch-Pitts Neuron (MCP) framework.

13. The system of claim 11, wherein the AI/ML module includes a self-training module and a self-learning module, the AI/ML module hosted on the computing device, wherein the computing device comprises at least one of a Central Processing Unit (CPU), a Graphics Processing Unit (GPU) and a Tensor Processing Unit (TPU), wherein the at least one of the CPU, GPU and TPU is coupled to a memory.

14. The system of claim 11, wherein the AI/ML module is configured to receive feedback on the knowledge assessment items generated from the source.

15. The system of claim 14, wherein the feedback is validated by the source, the source comprising at least one of an examination administrator, a client and an authorized third party on behalf of the client wherein feedback acting as input for model learning.

16. The system of claim 11, wherein the content comprises at least one of an audio source, a video source, a journal, a book, a hyperlink and a combination thereof, wherein the hyperlink includes content therein.

17. The system of claim 11, wherein the set of parameters provided as input comprises at least a total number of knowledge assessment items to be generated, and the total number of knowledge assessment items to be generated further comprises:
at least one of an item type; and
at least a maximum number of knowledge assessment items to be created under each of the item type.

18. The system of claim 17, wherein the each of the knowledge assessment item comprises at least one of
a stem and a set of keys for the stem;
a stem, a set of keys for the stem and a set of distractors for the stem; and
a stem and an input requirement for the stem, wherein the input requirement for the stem is provided by the candidate, and
wherein the number of keys and the number of distractors for each item is specified by the source, wherein the number of keys and the number of distractors for a stem is determined based on the item type.

19. The system of claim 11, wherein if an item type is not specified by the source, the AI/ML model is configured to self-generate knowledge assessment items of different item types, wherein a total number of knowledge assessment items generated from the content not exceeding the total number of total items specified by the source.

20. The system of claim 11, wherein at least one of
the source is configured to scrutinise and approve the knowledge assessment item generated by the AI/ML module, and provide feedback with respect to the knowledge assessment item, wherein the feedback provided trains the AI/ML module; and
a subject matter expert configured to offer suggestions to change the knowledge assessment item generated by the AI/ML module and provide feedback the change suggested to the knowledge assessment item, wherein the feedback is provided to train the AI/ML module.

21. A computer-readable non-transitory memory having instructions stored thereon, the instructions when executed in one or more processors causing the one or more processors to implement operations comprising:
receiving as input, content and at least a set of parameters from a source;
based on the input received, the AI/ML module adapted to perform an action, the action comprising:
generating at least one or more knowledge assessment items from the content received as input, wherein the item is at least one of a dichotomous item type or a polychotomous item type; and
providing as output at least the one or more knowledge assessment items with respect to the content provided as input.
